(19) United States
(12) Patent Application Publication
(10) Pub. No.: US 2013/0188344 A1
(43) Pub. Date: Jul. 25, 2013

(54) LIGHTING DEVICE

(71) Applicant: Diehl Aerospace GMBH, Ueberlingen (DE)

(72) Inventors: Stefan DOBLER, Neunkirchen am Brand (DE); Thomas UTH, Klein Krankow (DE); Mathias Donner, Rostock (DE)

(73) Assignee: DIEHL AEROSPACE GMBH, Ueberlingen (DE)

(21) Appl. No.: 13/746,715

(22) Filed: Jan. 22, 2013

(30) Foreign Application Priority Data
Jan. 24, 2012 (DE) 102012001382.5

(51) Int. Cl. F21V 21/005

(52) U.S. Cl. CPC F21V 21/005
USPC 362/223

(57) ABSTRACT

The invention relates to a lighting device for illumination in an aircraft cabin, having a U-section (1) made of aluminium,

wherein the U-section (1) comprises two limbs (3) extending from an inner side of a section baseplate (2),

wherein at least one circuit board (4) carrying a multiplicity of LEDs (5) is mounted on an outer side (A) of the section baseplate (2), opposite the inner side, in such a way that heat generated during operation of the LEDs (5) is at least partially dissipated via the U-section (1), and

wherein a transparent cover (6) configured in the form of a further U-section, which permits an emission angle (α) of from 150° to 180° with respect to a section plane extending perpendicularly through the limbs (3) and the section baseplate (2), is applied on the U-section (1).

### BACKGROUND OF THE INVENTION

The invention relates to a lighting device for the illumination of an aircraft cabin.

### DISCUSSION OF THE PRIOR ART

According to the prior art, U-sections made of aluminium and matching transparent covers are available for the production of lighting devices. In this case, the U-sections are configured in such a way that lighting means are applied on an inner side of a section baseplate, between their two limbs. The transparent covers are applied in such a way that they cover the two limbs of the U-sections.

Light-emitting diodes, or LEDs, may be used as lighting means in such lighting devices. The heat generated during the operation of LEDs is at least partially dissipated by the U-section made of aluminium. Particularly when such lighting devices are equipped with powerful LEDs, a relatively large amount of heat is given off during operation. In order to improve the cooling of such lighting devices, elaborately configured U-sections are now used, which, for example, in addition to the section baseplate comprise a parallel support plate connected thereon via webs. Although the thermal dissipation can be improved by using such U-sections, a disadvantage of such U-sections is, however, their high weight. Particularly in the field of aircraft construction, according to the prior art there is a need for lightweight, energy-saving lighting devices which are also simple and economical to produce.

### SUMMARY OF THE INVENTION

It is an object of the invention to eliminate the disadvantages according to the prior art. In particular, the intention is to provide a lightweight, energy-saving lighting device which is simple and economical to produce. According to another aim of the invention, the lighting device should be suitable in particular for the illumination of aircraft cabins.

The object is achieved by the features of Patent claim 1. Expedient configurations of the invention may be derived from the features of claims 2 to 5.

According to the invention, a lighting device for illumination in an aircraft cabin is provided, having a U-section made of aluminium, wherein the U-section comprises two limbs extending from an inner side of a section baseplate, wherein at least one circuit board carrying a multiplicity of LEDs is mounted on an outer side of the section baseplate, opposite the inner side, in such a way that heat generated during operation of the LEDs is at least partially dissipated via the U-section, and wherein a transparent cover configured in the form of a further U-section, which permits an emission angle of from 150° to 180° with respect to a section plane extending perpendicularly through the limbs and the section baseplate, is applied on the U-section.

The proposed lighting device can be produced by using a conventional U-section. Because according to the invention a circuit board carrying the LEDs is applied not on the inner side of the section baseplate but on the opposite outer side, improved thermal dissipation can be achieved. According to the invention, the two limbs of the U-section no longer form a component of a housing which encloses the LEDs. They face away from the housing and therefore permit particularly efficient thermal dissipation. Furthermore, in the configuration proposed according to the invention, the two limbs of the U-section can be used expediently for fastening of the lighting device. Because the circuit board carrying the LEDs is applied on the outer side of the section baseplate, an improved emission angle can furthermore be achieved owing to the provision of the transparent cover configured according to the invention in the form of a further U-section. As a result of this, the luminous efficiency of the proposed lighting device is improved.

Aside from this, the proposed lighting device can be produced simply and economically. It is distinguished by a particularly low weight. As a result of this, the proposed lighting device is suitable in particular for use in aircraft construction, or for the illumination of an aircraft cabin.

In the context of the present invention, the terms “U-section” and “further U-section” are to be interpreted in the general sense. The limbs of such sections need not necessarily be formed so that they are flat. They may also comprise grooves and/or ribs essentially extending parallel to the baseplate. Furthermore, the limbs may also have a slight bend in profile. They need not necessarily extend from the section baseplate at an angle of 90°, which is regarded as preferred. Orientation angles in the range of from 70° to 110° are also possible. A further section baseplate of the further U-section may also have a bend in profile.

According to an advantageous configuration, the cover is retained by means of latching projections provided thereon in first recesses corresponding thereto on the limbs. It is therefore readily possible to fasten the cover on the U-section without the provision of additional fastening means. According to another configuration of the invention, on its two narrow sides the section baseplate respectively comprises a wall, preferably produced by bending, extending from the outer side. The wall is expediently configured in such a way that, when the cover is placed on the U-section, an opening remaining on the narrow sides of the U-section is essentially closed by the wall. The production of the wall, which is preferably achieved by bending, can be carried out simply and economically.

According to another advantageous configuration of the invention, a power supply unit for supplying the circuit board with direct current having a voltage in the range of from 35 to 45 V, preferably from 38 to 42 V, is held between the limbs of the U-section. The proposed configuration is particularly compact. The power supply unit is accommodated at least partially in a space between the limbs. By the power supply unit, an on-board system voltage of an aircraft rated at 150 V AC is expediently converted into a rating of 40 V DC.

Furthermore, it has proven expedient for second recesses to be provided in the limbs for the engagement of fastening elements for fastening the U-section on an inner side of the cabin. By means of this, the proposed lighting device can be latched simply and rapidly in, for example, clip-like retaining elements provided on an inner side of the cabin.

### BRIEF DESCRIPTION OF THE DRAWINGS

An exemplary embodiment of the invention will be explained in more detail below with the aid of the drawings, in which:

FIG. 1 shows a perspective exploded representation of a lighting device,

FIG. 2 shows a side view according to FIG. 1,

FIG. 3 shows a plan view according to FIG. 2 and

FIG. 4 shows a sectional view according to the section line A-A′ in FIG. 2.

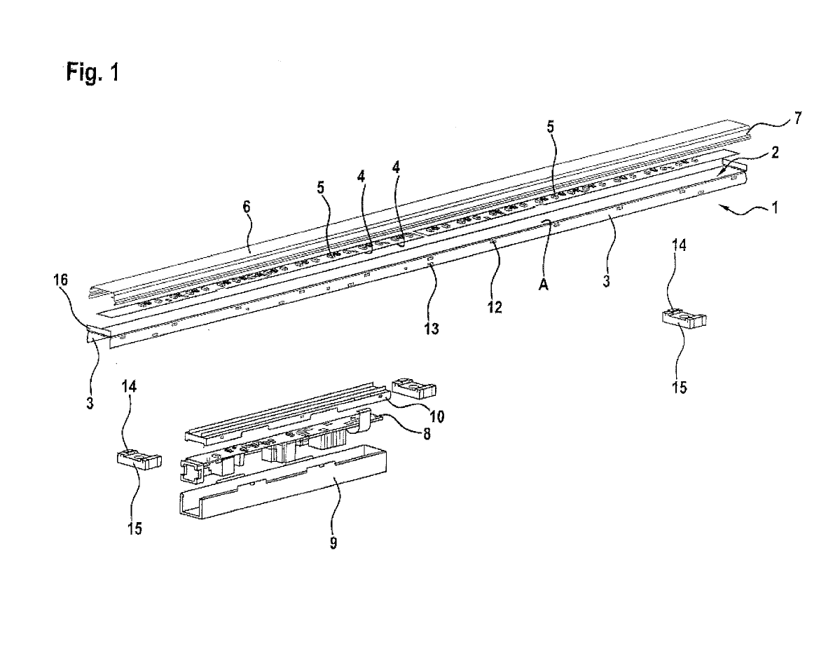

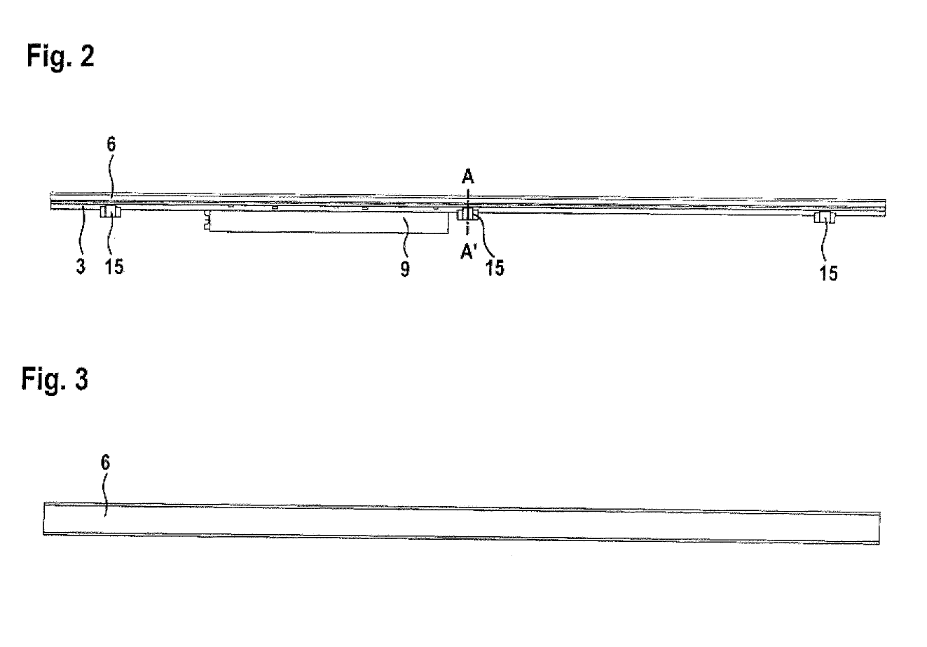

### DETAILED DESCRIPTION OF THE INVENTION

In the lighting device shown in the figures, a U-section 1 made of aluminium comprises a section baseplate 2 and two limbs 3 extending therefrom. An inner side of the section baseplate 4 cannot be seen in the figures. An outer side of the section baseplate 2 is denoted by the reference A.

A plurality of circuit boards 4 are mounted on the outer side A, which in turn carry a multiplicity of LEDs 5. The reference 6 denotes a transparent cover, which is configured in the form of a further U-section. The cover 6 comprises further limbs 7.

The reference 8 denotes a power supply unit, which is accommodated in a housing 9. A housing lid is denoted by the reference 10.

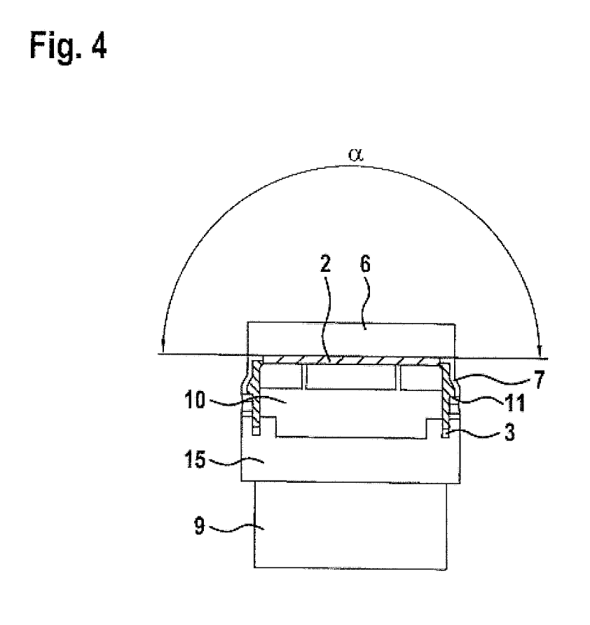

As can be seen in particular from FIG. 4, the further limbs 7 comprise latching projections 11 which are provided in order to engage into first recesses 12 corresponding thereto on the limbs 3. The reference 13 denotes two recesses on the limbs 3, into which further latching projections 14 that are provided on retaining clips 15 engage. The retaining clips 15 are used to fasten the lighting device, for example on a cabin ceiling or wall. The recesses 12, 13 are preferably holes provided in the limbs 3.

Lastly, the reference 16 denotes walls which extend on the narrow sides of the section baseplate 2. Such walls may be produced by bending.

As can be seen from the figures, the limbs 3 are used in order to fasten the lighting device. The limbs 3 are not a component of a housing which encloses the LEDs 5. Their inner surfaces, facing towards one another, are thus not exposed to heat prevailing in the housing, but are used to dissipate the heat from the housing. The inner surfaces of the limbs 3, which substantially lie free in relation to the surroundings, can effectively dissipate heat generated by the LEDs 5 during operation to the surroundings. As can be seen in particular from FIG. 4, application of the circuit boards 4 on the outer side A of the section baseplate 2 permits emission of the light generated by the LEDs 5 in an emission angle α of 180°.

### LIST OF REFERENCES

1 U-section

2 section baseplate

3 limb

4 circuit board

5 LED

6 transparent cover

7 further limb

8 power supply unit

9 housing

10 housing lid

11 latching projection

12 recess

13 further recess

14 further latching projection

15 retaining clip

16 wall

A outer side

α a emission angle

What is claimed is:

1. A lighting device for illumination in an aircraft cabin, having a U-section made of aluminium,
wherein the U-section comprises two limbs extending from an inner side of a section baseplate,
wherein at least one circuit board carrying a multiplicity of LEDs is mounted on an outer side of the section baseplate, opposite the inner side, in such a way that heat generated during operation of the LEDs is at least partially dissipated via the U-section, and
wherein a transparent cover configured in the form of a further U-section, which permits an emission angle (α) of from 150° to 180° with respect to a section plane extending perpendicularly through the limbs and the section baseplate, is applied on the U-section.

2. The lighting device according to claim 1, wherein the cover is retained by means of latching projections provided thereon in first recesses corresponding thereto on the limbs.

3. The lighting device according to claim 1, wherein, on its two narrow sides, the section baseplate respectively comprises a wall, extending from the outer side (A).

4. The lighting device according to claim 3, wherein side wall is produced by bending.

5. The lighting device according to claim 1, wherein a power supply unit for supplying the circuit board with direct current having a voltage in the range of from 35 to 45 V is held between the limbs of the U-section.

6. The lighting device according to claim 5, wherein said power supply unit has a voltage in the range of from 38 to 42 V.

7. The lighting device according claim 1, wherein second recesses are provided in the limbs for the engagement of fastening elements for fastening the U-section on an inner side of the cabin.
